(19) United States
(12) Patent Application Publication
(10) Pub. No.: US 2015/0358791 A1
(43) Pub. Date: Dec. 10, 2015

(54) SYSTEM ARCHITECTURE FOR MULTIPLE ANTENNA/SERVICES REMOTE RADIO HEAD

(71) Applicant: AVIACOMM INC., Sunnyvale, CA (US)

(72) Inventors: Hans Wang, Mountain View, CA (US); Tao Li, Campbell, CA (US); Binglei Zhang, San Jose, CA (US); Shih Hsiung Mo, San Jose, CA (US)

(73) Assignee: AVIACOMM INC., Sunnyvale, CA (US)

(21) Appl. No.: 14/731,274

(22) Filed: Jun. 4, 2015

Related U.S. Application Data
(60) Provisional application No. 62/008,816, filed on Jun. 6, 2014.

(51) Int. Cl. H04W 4/18; H04L 29/06

(52) U.S. Cl. CPC H04W 4/18; H04L 29/06; H04W 88/085

(57) ABSTRACT

One embodiment of the present invention provides a remote radio head (RRH) for a wireless communication system. The RRH includes a first integrated circuit (IC) chip that comprises multiple functional blocks, a second IC chip that comprises at least a frequency up-converter for up-converting outputs of the DAC block to a radio frequency (RF) domain and a frequency down-converter for down-converting RF signals received from one or more antennas, and a plurality of RF front-end components that are packaged into a system in a package (SiP) module. The multiple functional blocks in the first IC chip include at least a processing unit, a digital-to-analog converter (DAC) block, and an analog-to-digital converter (ADC) block.

### RELATED APPLICATION

This application claims the benefit of U.S. Provisional Application No. 62/008,816, Attorney Docket Number AVC14-1003PSP, entitled “System Architecture for Multiple Antenna/Services Remote Radio Head (RRH),” by inventors Hans Wang, Tao Li, Binglei Zhang, and Shih Hsiung Mo, filed 6 Jun. 2014.

### BACKGROUND

1. Field

The present disclosure relates generally to a remote radio head (RRH) for a wireless communication system. More specifically, the present disclosure relates to an RRH architecture that is low cost, has a small form factor, and consumes less power.

2. Related Art

Remote radio head (RRH) plays an important role in wireless communication systems. RRH equipment is used to extend the coverage of a base station to regions like rural areas or tunnels. In practice, RRH equipment is connected to the base station via a fiber optic cable using a Common Public Radio Interface (CPRI) protocol.

A typical RRH includes the base station's radio frequency (RF) circuitry, such as the RF transceiver and RF front end, digital-to-analog converter (DAC), analog-to-digital converter (ADC), optical transceiver for interfacing with the base station, and a field-programmable gate array (FPGA) handling the CPRI. When deployed, the RRHs are often installed at outdoor locations close to the antenna, such as at the top of the cell tower. Among many requirements, low unit cost, a small form factor, and low power consumption are key design requirements for RRH systems.

### SUMMARY

One embodiment of the present invention provides a remote radio head (RRH) for a wireless communication system. The RRH includes a first integrated circuit (IC) chip that comprises multiple functional blocks, a second IC chip that comprises at least a frequency up-converter for up-converting outputs of the DAC block to a radio frequency (RF) domain and a frequency down-converter for down-converting RF signals received from one or more antennas, and a plurality of RF front-end components that are packaged into a system in package (SiP) module. The multiple functional blocks in the first IC chip include at least a processing unit, a digital-to-analog converter (DAC) block, and an analog-to-digital converter (ADC) block.

In a variation on this embodiment, the processing unit is configured to facilitate communications between a base station and the RRH, and the communications are in compliance with one of: a Common Public Radio Interface (CPRI) protocol and an Open Base Station Architecture Initiative (OBSAI) protocol.

In a variation on this embodiment, the processing unit is configured to simultaneously process multiple streams of data in both uplink and downlink directions.

In a further variation, the processing unit is configured to simultaneously process four or eight data streams in each of the uplink and downlink directions.

In a variation on this embodiment, the DAC block is configured to DA convert multiple data streams in parallel, and the ADC block is configured to AD convert multiple signal streams in parallel.

In a variation on this embodiment, the first IC chip and the second IC chip are coupled via an analog interface.

In a variation on this embodiment, the plurality of RF front-end components includes one or more of: a filter, a switch, a power amplifier, and a low-noise amplifier.

In a variation on this embodiment, the RRH further includes an optical transceiver module situated between the first IC chip and the base station.

In a variation on this embodiment, the first IC chip has a channel capacity that is greater than the second IC chip, and the RRH further includes a third IC chip that is identical to the second IC chip.

### BRIEF DESCRIPTION OF THE FIGURES

FIG. 1 presents a diagram illustrating the architecture of a wireless network that implements remote radio head.

FIG. 2 presents a diagram illustrating the architecture of a conventional single channel RRH (prior art).

FIG. 3 presents a diagram illustrating the exemplary architecture of a multi-stream RRH, in accordance with an embodiment of the present invention.

FIG. 4 presents a diagram illustrating the exemplary architecture of an SoC module implemented in a multi-stream RRH, in accordance with an embodiment of the present invention.

FIG. 5 presents a diagram illustrating the exemplary architecture of an RFIC module, in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

Embodiments of the present invention provide an RRH architecture that is low-cost, highly integrated, and power efficient. The proposed RRH architecture includes an optical transceiver module, a system on a chip (SoC) module, one or more RF integrated circuit (RFIC) chips, and one or more system in a package (SiP) modules. More specifically, the SoC module includes an FPGA-based CPRI interface and multiple ADC/DAC modules, with each ADC/DAC module for a particular channel. Each RFIC chip includes multiple RF transceivers, with each transceiver for a particular channel. An SiP module can include multiple discrete components, such as power amplifiers (PAs), switches, and filters. The RRH may also include additional components, such as power-control circuits and oscillators.

### Multi-Stream Remote Radio Head

RRH has become a key component in modern-day wireless networks, such as the long-term evolution (LTE) network. The deployment of RRHs can reduce the carrier's requirement for site resources and investment while improving the effect of coverage. Moreover, placing RRHs at locations close to the antenna reduces feeder line loss. RRH can also support the need for coverage at special locations, such as along high-speed railways.

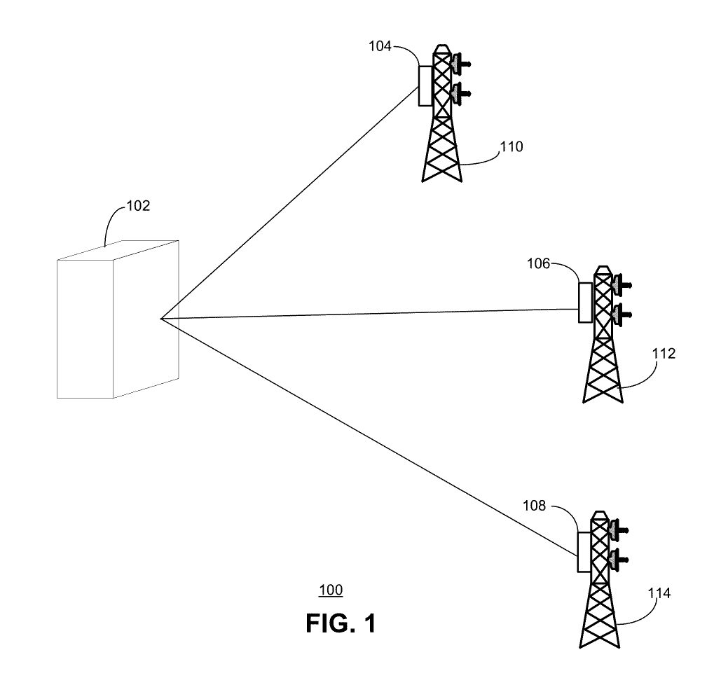

FIG. 1 presents a diagram illustrating the architecture of a wireless network that implements remote radio head. In FIG. 1, wireless network 100 includes a base station 102 and a number of towers, such as towers 110, 112, and 114. Note that base station 102 may only include basic baseband processing modules, such as a digital signal processor (DSP), and the control circuitry. Other RF front-end functionalities are handled by RRHs. Each tower can be equipped with one or more RRHs that are coupled to the one or more antennas located on the tower. For example, tower 110 includes an RRH 104. A typical RRH can include standard RF front-end components, such as ADCs/DACs, modulators/demodulators, amplifiers, filters, switches, etc. In addition, the RRH often includes an optical interface for communicating with the base station. A high level of integration, low power loss, and small size are key design requirements for RRHs. Such requirements can be a challenge, especially in long-term evolution (LTE) wireless networks that implement multi-input multi-output (MIMO) technology.

In LTE networks, there are various MIMO implementations, such as: receive diversity (a single data stream is transmitted on one antenna and received by multiple antennas), transmit diversity (a single data stream is transmitted over multiple antennas), spatial multiplexing (multiple data streams are transmitted over multiple antennas), multi-user MIMO (MU-MIMO), and beam-forming (using antenna arrays to focus transmission to a particular area). Among the various MIMO implementations, the beam-forming scheme is the most complex. However, by enabling the antenna to focus on a particular area, this MIMO implementation reduces interference and increases capacity, because a particular user equipment (UE) will have a beam formed in its particular direction. To implement MIMO in the beam-forming mode, an RRH needs to provide multiple correlated data streams (which may occupy the same frequency band) to the multiple antennas. Therefore, a single RRH device may need to handle the multiple correlated data streams. In other words, the RRH device needs to have more than one channel. For example, to implement 2×2 or 4×4 MIMO, a single RRH device needs to have a capacity of four or eight channels (considering each quadrature-modulated data stream may need two signal paths).

In addition to supporting the multiple antenna application, an RRH may also need to support multiple services by transmitting/receiving signals for multiple different carriers or signals of the same carrier occupying multiple different frequency bands. In such scenarios, the RRH may need to provide multiple un-correlated data streams (often occupying different frequency bands) to a single antenna. Similarly, to enable the multi-service transmission/receiving, an RRH needs to have a multi-stream capacity.

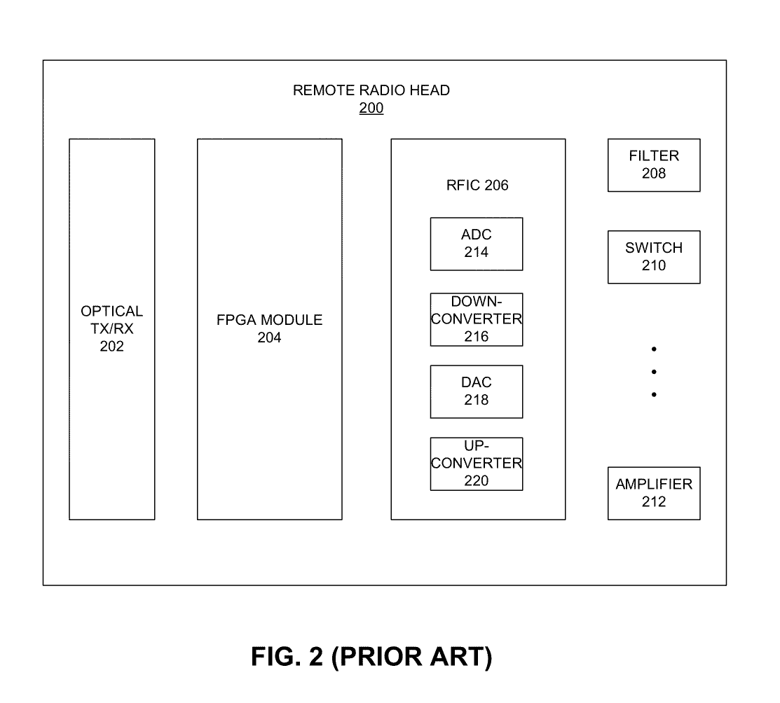

FIG. 2 presents a diagram illustrating the architecture of a conventional single channel RRH (prior art). In FIG. 2, an RRH 200 includes an optical transceiver 202, an FPGA module 204, an RFIC module 206, and a number of RF front-end components, such as a filter 208, a switch 210, an amplifier 212, etc.

Optical transceiver 202 interfaces with the base station via optical fibers, and transmits/receives baseband digital signals. FPGA module 204 typically includes a standard CPRI interface. Note that the CPRI interface is a standardized interface between the radio equipment control (REC) and the radio equipment (RE) in wireless base stations, thus allowing interoperability of equipment from different vendors, while preserving the software investment made by wireless service providers. In cases of RRH, the REC remains at the base station, and the RE is the RRH. In addition to the CPRI interface, FPGA module 204 also includes certain processing capabilities that can process operation and maintenance signals originated from the base station.

RFIC module 206 includes a number of RF components that are integrated onto a single IC chip. More specifically, RFIC module 206 typically handles the conversion between digital data and analog signals, and the conversion between the intermediate frequency (IF) or baseband signals and the RF signals. To do so, a typical RFIC module 206 may include an ADC 214, a down converter 216, a DAC 218, and an up converter 220. ADC 214 and down converter 216 are part of the receiving path, and DAC 218 and up converter 220 are part of the transmission path. Note that for quadrature-modulated signals, each receiving (or transmission) path actually requires dual-channel ADC (or DAC) to handle the in-phase (I) and the quadrature (Q) signals.

From FIG. 2, one can see that it can be very challenging to increase the capacity of the conventional RRH because doubling the channel counts means that the number of components, such as ADCs, DACs, or the RF front-end components, also needs to be doubled. In addition, as the number of channels increases, so will the size and the power consumption of the FPGA module for handling the CPRI interface. There is another problem with the conventional RRH shown in FIG. 2. More specifically, in RRH 200, the integrated RFIC module 206 includes both the ADC/DAC modules and the up/down converters, meaning that analog and digital signals run on the same chip. The on/off switching of the ADC/DAC modules often generates noises at the RF components, e.g., the up/down converters. Certain designs try to mitigate such a noise problem by separating the ADC/DAC modules and the up/down converters. However, such arrangements often result in increased device size.

To overcome the noise problem, in some embodiments of the present invention, the ADC/DAC modules are placed on a separate chip away from other RF components. To ensure a smaller footprint, instead of being stand-alone components, the ADC/DAC modules are integrated with a CPRI interface processing unit to form a system on a chip (SoC) module. Moreover, multiple RF front-end components are packaged together into a system in a package (SiP) module, thus further reducing the overall size of the RRH.

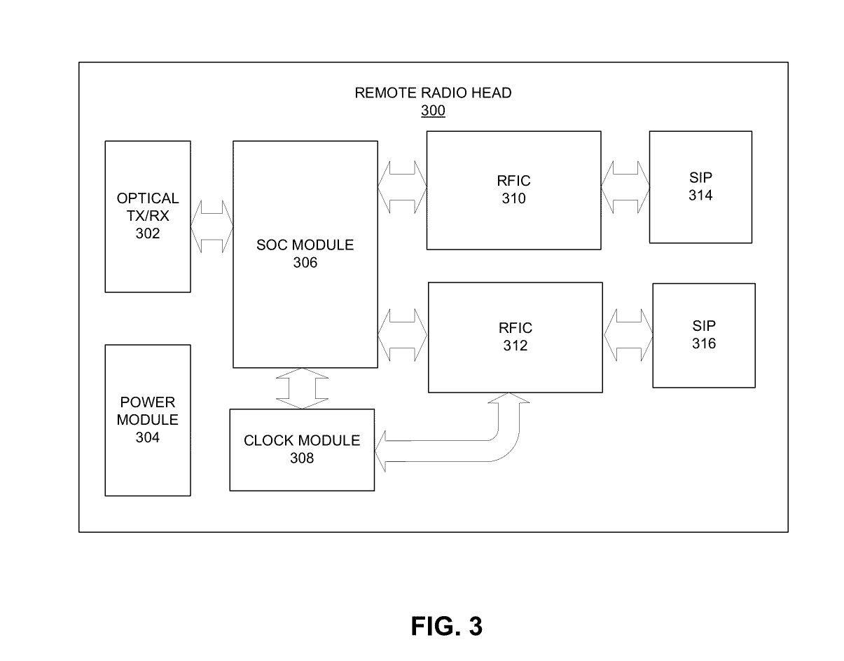

FIG. 3 presents a diagram illustrating the exemplary architecture of a multi-stream RRH, in accordance with an embodiment of the present invention. In FIG. 3, a multi-stream RRH 300 includes an optical transceiver module 302, a power module 304, an SoC module 306, a clock module 308, a number of RFIC modules (such as RFIC modules 310 and 312), and a number of SiP modules (such as SiP modules 314 and 316). In some embodiments, the various components of multi-stream RRH 300 can be mounted onto a single printed circuit board (PCB).

Optical transceiver module 302 provides the optical interface between RRH 300 and the base station. More specifically, optical transceiver module 302 couples to the base station via optical fibers to facilitate the exchange of data and control signals between RRH 300 and the base station. To enable multiple data streams in each direction, various multiplexing technologies, such as time-division multiplexing (TDM), can be used. In some embodiments, optical transceiver module 302 may provide up to eight data channels in each direction. Power module 304 includes the circuitry for the control and management of power. More specifically, power module 304 is responsible for providing powers to other modules/components in RRH 300, such as SoC module 306 and RFIC module 310.

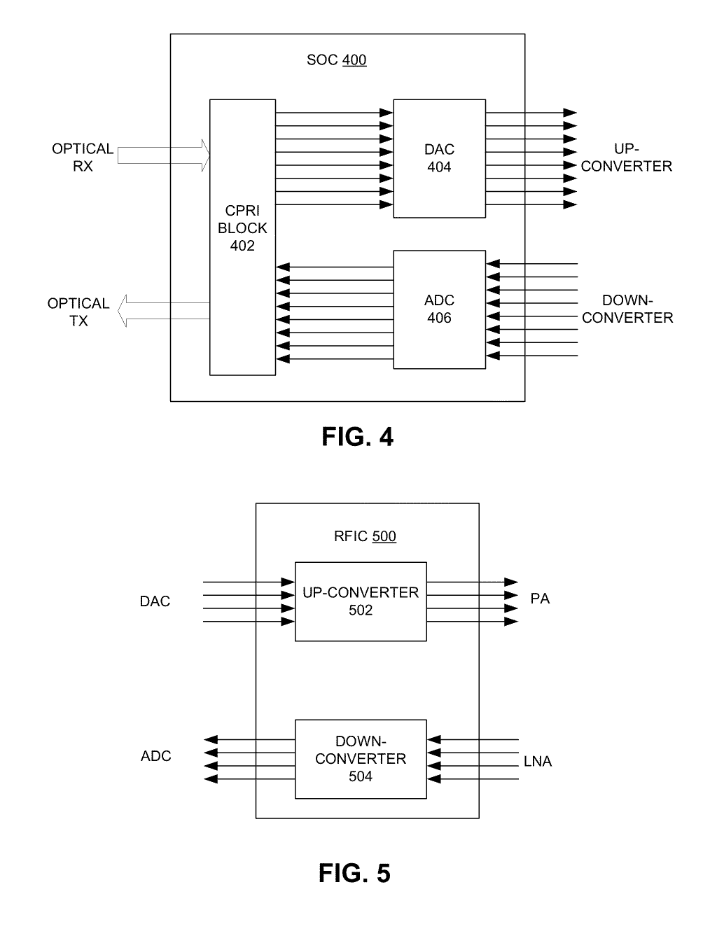

SoC module 306 is an integrated circuit (IC) chip that integrates multiple components (which can include both digital and analog components) onto a single chip substrate. In some embodiments, SoC module 306 includes a processor unit that handles the interface between the base station and RRH 300. In further embodiments, such an interface can be a CPRI interface or an Open Base Station Architecture Initiative (OBSAI) interface. FIG. 4 presents a diagram illustrating the exemplary architecture of an SoC module implemented in a multi-stream RRH, in accordance with an embodiment of the present invention. In FIG. 4, SoC module 400 includes multiple functional blocks, such as a CPRI block 402, a DAC block 404, and an ADC block 406. CPRI block 402 handles the CPRI interface to the base station (via the optical transceiver). More specifically, CPRI block 402 facilitates the exchange of user data, control and management, as well as synchronization signals between the base station and the RRH. Accordingly to the CPRI standard, the user data is transformed in the form of quadrature-modulated data (IQ data), and several IQ data flows can be sent via one physical CPRI link. Note that each IQ data flow reflects the data of one antenna for one carrier. Hence, multiple IQ data flows can reflect data to multiple antennas or data for multiple carriers.

In the example shown in FIG. 4, CPRI block 402 is capable of handling up to eight IQ data flows in each direction. More specifically, in the transmitting direction (TX), CPRI block 402 receives time-domain multiplexed (TDM) data flows from the base station via the optical receiver, de-multiplexes the data flows, and then processes each individual data flow. Note that the multiple data flows can include MIMO data to different antennas, data from different service providers, and data from the same provider but which is to be modulated to different RF frequency bands. After processing, the multiple data flows are sent to multi-stream DAC 404 for digital to analog conversion. For an IQ data flow entering CPRI block 402 with separate I and Q data, each IQ data flow will need two DAC channels. For an IQ data flow entering CPRI block 402 with combined I and Q data (e.g., the I and Q data have been digitally up-converted to an intermediate frequency (IF) and then combined), only one DAC channel is needed to convert the combined IQ data to an analog signal at IF. In FIG. 4, each arrow represents an IQ data flow. The outputs of DAC 404, which include the multiple IQ flows in analog forms, are then sent to the up-converters to be converted to RF domain.

In the receiving (RX) direction, multiple-channel ADC 406 receives multiple streams of down-converted RF signals, and converts them to digital data streams. For quadrature-modulated RF signals, two ADC channels may be needed to generate the separate I and Q data. The outputs of ADC 406, which include multiple data streams, are then sent to CPRI block 402. In FIG. 4, each arrow out of ADC block 406 represents an IQ data flow, which includes separated I channel data and Q channel data. CPRI block 402 then frames the received IQ data flows (which can involve placing appropriate frame headers), time-domain multiplexes the multiple IQ flows to a single data stream, and then sends the multiplexed data to the base station via the optical transmitter.

Now return to FIG. 3, which shows SoC module 306 coupled to RFIC module 310 and RFIC module 312. In this example, each RFIC has half the channel capacity of SoC module 306. For example, if SoC module 306 has an 8-channel capacity (able to accommodate up to eight data streams in each direction), then each RFIC only needs to handle four data streams in each direction (TX and RX). This makes it easier for the RFIC to meet the wide-band requirement.

FIG. 5 presents a diagram illustrating the exemplary architecture of an RFIC module, in accordance with an embodiment of the present invention. In FIG. 5, RFIC 500 includes an up-converter block 502 and a down-converter block 504. Up-converter block 502 receives outputs from the DAC module, up converts the received analog signals to the RF domain, and then sends the RF signals to power amplifiers and antennas for transmission. In the example shown in FIG. 5, up-converter block 502 is capable of up-converting up to four channels of signals. In some embodiments, up-converter block 502 can include a number of mixers and phase shifters. The local oscillators (LOs) needed for the up-conversion can be off-chip, such as being part of clock module 308. In some embodiments, the LOs may be integrated into the RFIC.

On the other hand, down-converter block 504 receives amplified RF signals, down converts the RF signals to baseband or IF, and then sends the baseband or IF signals to the ADC module for analog-to-digital (AD) conversion. In the example shown in FIG. 5, down-converter block 504 is capable of down-converting up to four channels of signals. Similarly to up-converter block 502, down-converter block 504 may include a number of mixers and phase shifters. LOs that are needed for the down conversion may be located off-chip, such as being located within clock module 308. In some embodiments, the LOs may be located off-chip or integrated as part of the RFIC.

Now return to FIG. 3, which shows each RFIC coupled to an SiP module. For example, RFIC 310 couples to SiP module 314, and RFIC 312 couples to SiP module 316. Each SiP module includes a number of RF front-end components, such as filters, amplifiers, switches, etc., that are needed for the transmission and receiving of the RF signals. Note that the switches can include band-selection switches and TX/RX switches. In some embodiments, the number of RF front-end components included in the SiP module matches the RF channels on the corresponding RFIC. For example, if the RFIC can accommodate four signal channels, the corresponding SiP may include at least four power amplifiers (PAs) for amplification of the to-be-transmitted RF signals, and at least four low-noise amplifiers (LNAs) for amplification of received signals. By packaging multiple RF front-end components into an SiP module, embodiments of the present invention reduce the footprints of these front-end components, and hence ensure the compactness of the entire RRH module.

In general, compared with traditional schemes that rely on FPGAs to handle the interface to the base station (such as the CPRI or OBSAI interface), in embodiments of the present invention, the interface to the base station is integrated into an application-specific integrated circuit (ASIC) chip along with the ADC/DAC modules. More specifically, advanced CMOS technology (such as the 130 nanometer technology and beyond) ensures that such an ASIC chip has a much smaller footprint compared with FPGAs, thus making it possible to use a single chip to accommodate multiple data channels. In the examples shown in FIGS. 3 and 4, each ASIC chip or SoC module can accommodate up to eight data channels in each direction while maintaining a relatively small size. Moreover, using ASIC chips to handle the signal processing and the AD/DA conversion also reduces cost and power consumption.

Another advantage of the proposed RRH architecture is the separation of the ADC/DAC module and the up/down converters. In the examples shown in FIGS. 3-5, the ADC/DAC modules are located on an ASIC chip along with the CPRI or OBSAI interface, while the up/down converters are located on a separate RFIC chip. Such an arrangement ensures that all signals in and out of the RFIC chip are analog signals. More specifically, the interface between the RFIC and the SoC module and the interface between the RFIC and the SiP module are pure analog interfaces, which are less complex and consume less power compared to an interface of mixed (digital and analog) signals. The separation of the ADC/DAC and the RF components also prevents the switching noise of the DAC/ADC module from interfering with RF signals running on the RFICs.

Note that the architecture shown in FIGS. 3-5 is merely exemplary and should not limit the scope of this disclosure. For example, in FIG. 4, SoC module 400 includes CPRI block 402, which accommodates eight data channels in each direction. In practice, SoC module 400 may include an OBSAI interface, and the CPRI or OBSAI interface may accommodate more or fewer data channels. Similarly, although shown in FIG. 4 as having eight channels each, DAC module 404 and ADC module 406 may have more or fewer channels.

In addition, FIG. 5 shows that RFIC 500 includes an up-converter and a down-converter. In practice, RFIC 500 may also include other components that are needed for the receiving or transmission of RF signals, such as calibration modules, automatic gain control (AGC) modules, etc.

The foregoing descriptions of embodiments of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A remote radio head (RRH) for a wireless communication system, comprising:
a first integrated circuit (IC) chip that comprises multiple functional blocks, wherein the multiple functional blocks include at least a processing unit, a digital-to-analog converter (DAC) block, and an analog-to-digital converter (ADC) block;
a second IC chip that comprises at least a frequency up-converter for up-converting outputs of the DAC block to radio frequency (RF) domain and a frequency down-converter for down-converting RF signals received from one or more antennas; and
a plurality of RF front-end components that are packaged into a system in a package (SiP) module.

2. The RRH of claim 1, wherein the processing unit is configured to facilitate communications between a base station and the RRH, and wherein the communications are in compliance with one of:
a Common Public Radio Interface (CPRI) protocol; and
an Open Base Station Architecture Initiative (OBSAI) protocol.

3. The RRH of claim 1, wherein the processing unit is configured to simultaneously process multiple streams of data in both uplink and downlink directions.

4. The RRH of claim 3, wherein the processing unit is configured to simultaneously process four or eight data streams in each of the uplink and downlink directions.

5. The RRH of claim 1, wherein the DAC block is configured to DA convert multiple data streams in parallel, and wherein the ADC block is configured to AD convert multiple signal streams in parallel.

6. The RRH of claim 1, wherein the first IC chip and the second IC chip are coupled via an analog interface.

7. The RRH of claim 1, wherein the plurality of RF front-end components includes one or more of:
a filter;
a switch;
a power amplifier; and
a low-noise amplifier.

8. The RRH of claim 1, further comprising an optical transceiver module situated between the first IC chip and the base station.

9. The RRH of claim 1, wherein the first IC chip has a channel capacity that is greater than the second IC chip, and wherein the RRH further comprises a third IC chip that is identical to the second IC chip.

10. A system on a chip (SoC) module for application of a remote radio head (RRH), comprising:
a processing unit configured to facilitate communications between a base station and the RRH;
a digital-to-analog converter (DAC) block; and
an analog-to-digital converter (ADC) block.

11. The SoC module of claim 10, wherein the communications between the base station and the RRH are in compliance with one of:
a Common Public Radio Interface (CPRI) protocol; and
an Open Base Station Architecture Initiative (OBSAI) protocol.

12. The SoC module of claim 10, wherein the processing unit is configured to simultaneously process multiple streams of data in both uplink and downlink directions.

13. The SoC module of claim 12, wherein the processing unit is configured to simultaneously process four or eight data streams in each of the uplink and downlink directions.

14. The SoC module of claim 10, wherein the DAC block is configured to DA convert multiple data streams in parallel, and wherein the ADC block is configured to AD convert multiple signal streams in parallel.

15. The SoC module of claim 10, wherein the SoC module is coupled to the base station via an optical transceiver.

16. The SoC module of claim 10, wherein the SoC module is coupled to a radio frequency integrated circuit (RFIC) chip via an analog interface.
